(19) United States
(12) Patent Application Publication
(10) Pub. No.: US 2010/0259046 A1
(43) Pub. Date: Oct. 14, 2010

(54) ACTIVE CONTROL SURFACES FOR WIND TURBINE BLADES

(76) Inventors: Sridhar Kota, Ann Arbor, MI (US); Gregory F. Ervin, Novi, MI (US); Dragan Maric, Ann Arbor, MI (US); James D. Ervin, Novi, MI (US); Paul W. Keberly, Canton, MI (US)

Correspondence Address: Rohm & Monsanto, PLC, 12 Rathbone Place, Grosse Point, MI, 48230, US

(21) Appl. No.: 12/734,532

(22) PCT Filed: Nov. 6, 2008
(86) PCT No.: PCT/US08/12584

§ 371 Date: May 6, 2010

Related U.S. Application Data
(60) Provisional application No. 61/001,999, filed on Nov. 6, 2007.

(51) Int. Cl. H02P 9/04; F01D 7/00; F03D 7/04; F01D 5/14

(52) U.S. Cl. 290/44; 416/23; 416/41; 416/223 R

(57) ABSTRACT

A wind turbine has a longitudinal airfoil blade that exerts a torque on the generator in response to an impinging air current. A compliant airfoil edge arrangement is disposed along an edge of the airfoil blade for at least a portion of a longitudinal dimension of the airfoil blade. A morphing drive arrangement varies a configuration of the compliant airfoil edge arrangement and consequently the aerodynamic characteristics of the airfoil blade. A drive arrangement applies actuation forces to the upper and lower compliant surfaces via the upper and lower actuation elements. The compliant airfoil edge is arranged as a trailing edge of the airfoil blade.

### RELATIONSHIP TO OTHER APPLICATION

This application is a continuation-in-part of international patent application Serial Number PCT/US2007/010438, filed on Apr. 27, 2007, which designates the United States and claims the benefit of the filing date of U.S. Provisional Patent Application Ser. No. 60/795,956, filed Apr. 27, 2006, and additionally claims the benefit of the filing date of U.S. Provisional Patent Application Ser. No. 61/001,999 filed Nov. 6, 2007. The disclosures in these applications are incorporated herein by reference.

### BACKGROUND OF THE INVENTION

1. Field of the Invention

This invention relates generally to resilient systems, and more particularly, to a resilient air foil arrangement that has a variable aerodynamic configuration, and that is particularly adapted for use in a wind turbine.

2. Description of the Prior Art

Fatigue loads dictate the lifetime of all wind turbine components. The blade of a wind turbine is the means to capturer wind energy. As the wind conditions (speed and direction) change, the energy transfer to the generator, mechanical and structural loads imposed on the blade, the gearbox, and the tower (or stanchion) change accordingly. It is important to capture wind energy at low wind speeds while protecting the infrastructure (blades, gearbox, tower etc.) from damaging stresses that could lead to failure.

Fatigue loads are a major wind turbine design driver. The blades must be designed to sustain high wind gusts while capturing energy efficiently under low and moderate wind conditions. Numerous studies have shown that the fatigue loads on wind turbine blades can be significantly reduced with the use of distributed, fast-response, active aerodynamic load control devices such as small trailing edge flaps.

Current Challenges with Wind Turbine Technology

The theoretical maximum efficiency of a turbine is 59.3%. Modern wind turbines operate surprisingly close to that, illustratively at about 50% efficiency. The Rayleigh wind speed distribution provides a glimpse of challenges in extricating even a very few additional percentage points of efficiency.

Larger blades capture more energy since the energy captured is directly related to the swept area. Larger blades also impose severe stresses on the blade root and the infrastructure when wind gusts strike the blade. There is a need to reduce fatigue damage to the blade, as well as the load stresses that are transferred to the gear box. Such reduction in load stresses are very critical to longevity of the wind turbine system.

The cost increases in raw materials are driving up the cost of turbines, and wind-generated cost of energy (COE) is currently competitive only at the higher-wind sites that tend to be far from population centers (thus requiring the building of costly transmission lines to get the electricity to market). However, there is an opportunity to reduce the turbine COE.

Fatigue Loads and Methods of Control

One way to improve COE is to limit the fatigue loads that the rotor must withstand. Oscillating (fatigue) loads occur as a result of rotor yaw errors, wind shear, wind up flow, shaft tilt, wind gusts, and turbulence in the wind flow. These fatigue loads are often a primary consideration in turbine design. If the level of these loads can be reduced, some of the material can be removed from the rotor, the tower, and the drive train, consequently reducing the capital cost of the turbine and the COE. Alternatively, a larger diameter rotor can be placed on an existing tower and drive train, resulting in additional energy capture and reducing the COE. Methods of controlling fatigue loads include the blade pitch (collective or individual), passive bend-twist coupling, conventional flaps, and active morphing of the control surfaces.

Blade pitch control provides a means for pitching all the blades in concert around their longitudinal axis, thereby changing the effective angle of attack. Such collective pitch control means is used to limit the average loads and is not effective in controlling the severe loads imposed due to wind gusts and turbulence. Rather than Collective Pitch, researchers have tried controlling the blades individually, called “IBC—Individual Blade Control.” The large size of the blades on modern turbines creates non-uniform flow along the length of the blade and therefore pitching of the entire blade is not effective. Blades must be locally controlled to be effective. Additionally, large blades cannot be pitched quickly enough to relieve fatigue loads due to wind gusts and turbulence.

Recently researchers have investigated passive bend-twist coupling. One way to accomplish that is to design the blade so that it can flex when the wind blows too strongly, and thus shed part of the wind. This is called passive control. A passively controlled blade can continue to run when conventional turbines must be shut down at high winds for sake of safety. A drawback of such a system includes the need to tune the blade design and construction for each wind site. Therefore, an active means for controlling locally the blade shape is desirable to reduce fatigue loads, increase energy capture, and reduce the cost of wind energy.

A truly effective means of reducing the fatigue loads that occur at random and that vary along the length of the blade is to morph certain section of the blade quickly in response to external wind conditions. Such can be the leading edge or the trailing edge of the blade. Although the methods described in this invention apply to any such control surface, morphing the trailing edge seems to be a preferred way to control fatigue loads. The challenge is to design such a system that is can respond quickly to changing wind conditions and be reliable, durable, and cost-effective

Conventional trailing edge flaps such as the ones used on a typical aircraft, are hinged flaps and are used as high-lift devices during landing and takeoff. Normally during cruise, hinged flaps are not deployed as they cause severe drag due to flow separation caused by sharp change in flow surface due to a rigid hinge arrangement. If a hinged flap is used on a wind turbine, it would be inefficient and very unreliable. Conventional hinged flaps are not suitable for wind turbine blade applications because the surface discontinuities trigger blade stall, noise, and loss of power due to poor aerodynamic characteristics such as lift/drag ratio.

The process of designing a compliant structure shape morphing control surface is a highly interdisciplinary process that involves aerodynamics, structural mechanics, and kinematics. These components are all interrelated such that the final compliant structure design depends heavily on all three (FIG. 1). Essentially, aerodynamic analysis drives the ideal aerodynamic shapes and predicts the pressure distributions experienced by these shapes. Kinematics relates to shapes that are achievable given design limitations such as restricting elongation of the surface perimeter and minimizing curvature transitions that relate to structural stress. Note that the structure may be optimized around an intermediate target shape (called the medial strain position) that reduces forces and stresses over the entire shape change envelope. This places added importance on the target shape design as the medial strain shape must be able to accurately morph into the extreme target shapes.

It is an object of this invention is to provide an arrangement that actively morphs certain sections of a wind turbine blade to match the changing wind conditions. In doing so, the fatigue loads can be minimized. Thus, for example, when a wind gust strikes the blade, the active control morphs to a pre-determined camber or shape to limit the loads and stresses transferred to the blade, the gearbox, and the tower. This allows longer blades to be used safely to capture more energy without the risk of catastrophic failure resulting from wind gusts or wind shear.

### SUMMARY OF THE INVENTION

The foregoing and other objects are achieved by this invention, which provides a wind turbine of the type having at least one airfoil blade having a longitudinal configuration for exerting a torque on a generator in response to an impinging air current. In accordance with the invention, the wind turbine is provided with generator for producing electrical energy in response to the application of a rotatory force. A compliant airfoil edge arrangement is disposed along an edge of the airfoil blade for at least a portion of a longitudinal dimension of the airfoil blade. Additionally, a morphing drive arrangement varies a configuration of the compliant airfoil edge arrangement and thereby varying the aerodynamic characteristics of the airfoil blade and the compliant airfoil edge arrangement.

In one embodiment of the invention, there is provided a sensor for providing data responsive to a predetermined condition of operation of said compliant airfoil edge. The data issued by the sensor is applied to control, illustratively via a controller, the operation of the morphing drive in response to the data issued by said sensor. In some embodiments the sensor monitors ambient conditions that might affect the operation of the wind turbine, and in such embodiments, the sensor is disposed in the vicinity of the wind turbine, illustratively remotely in a field near the wind turbine. In other embodiments, a remote sensor will provide data to a plurality of wind turbines.

In one embodiment of the invention, the compliant airfoil edge is arranged as a trailing edge of the airfoil blade.

In a further embodiment of the invention, the morphing drive arrangement has a push-pull axial rod extending longitudinally along at least a portion of the airfoil blade. A linkage arrangement converts a longitudinal motion of the push-pull axial rod into translongitudinal motion.

The morphing drive arrangement has, in some embodiments, an electromechanical actuator that provides an actuation force for varying a configuration of the compliant airfoil edge arrangement. In other embodiments, the morphing drive arrangement includes a hydraulic actuator that provides an actuation force for varying a configuration of the compliant airfoil edge arrangement. In the hydraulic actuator embodiment, there is further provided a hydraulic pump for providing a pressurized hydraulic fluid. Also, a hydraulic line, or conduit, is arranged to extend along the airfoil blade for providing fluid coupling between the hydraulic pump and the hydraulic actuator.

In some embodiments of the hydraulic actuator embodiment, the morphing drive arrangement includes a motor for providing mechanical energy to the hydraulic pump. In other embodiments, however, the morphing drive arrangement includes a coupling arrangement for providing mechanical energy to the hydraulic pump in response to the torque exerted by the airfoil blade.

The operation of the wind turbine is improved, in accordance with the invention, by employing a sensor that provides data responsive to a predetermined condition of operation of the wind turbine. Such a predetermined condition corresponds, in various embodiments, to wind speed, turbine rotation, blade loading, actuator loading, stanchion loading, etc. A controller unit controls the operation of the hydraulic pump in response to the data issued by the sensor. Depending upon the type of data desired to be produced by the sensor, the sensor is disposed on the airfoil blade, the housing of the generator, the stanchion that supports the wind turbine, etc. Additionally, a sensor is, in some embodiments, arranged to provide data responsive to the extent of deformation of the compliant airfoil edge arrangement. Such a sensor can, in some embodiments, be a rotatory encoder. Moreover, as previously noted, the sensor is, in some embodiments of the invention, located in the vicinity of the wind turbine.

In a specific illustrative embodiment of the invention, there is provided a hydraulic valve for controlling the application of hydraulic pressure to the hydraulic actuator. In some embodiments, the hydraulic valve is actuated electrically. Illustratively, such electrical actuation is effected by a solenoid or similar electrical apparatus. However, in other embodiments, the hydraulic valve is actuated mechanically. For example, such mechanical actuation is effected by cables or shafts.

In an advantageous embodiment of the invention, the compliant airfoil edge arrangement is configured as a replaceable cartridge that is removably installed on the airfoil blade. The replaceable cartridge extends approximately between 10% and 90% of the longitudinal configuration of the airfoil blade, and in a practicable specific illustrative embodiment of the invention extends for approximately 25% of the longitudinal configuration of the airfoil blade. The replaceable cartridge is in some embodiments urged translongitudinally into communication with the airfoil blade. In other embodiments, however, the replaceable cartridge is installed by sliding same longitudinally along a groove or slot of the airfoil blade.

In a still further embodiment of the invention, there is provided a drive bar that extends along the compliant airfoil edge arrangement for facilitating coupling of the compliant airfoil edge arrangement with the morphing drive arrangement. In an advantageous embodiment, the drive bar is formed integrally with the compliant airfoil edge arrangement. In other embodiments, the drive bar imparts a predetermined stiffness characteristic to the compliant airfoil edge arrangement. In other embodiments, there is provided a stiffness control element for imparting a predetermined stiffness characteristic to the compliant airfoil edge arrangement.

Movable support for the morphing drive arrangement is provided in some embodiments by a linear bearing arrangement. In addition to supporting the morphing drive arrangement, the linear nearing arrangement will reduce the amount of energy required to effect the morphing of the compliant airfoil edge arrangement.

In a particularly advantageous embodiment of the invention, the compliant airfoil edge arrangement is provide with upper and lower surfaces that communicate with one another at an apex. The upper and lower surfaces are arranged to slide against one another at the apex.

In accordance with a further apparatus aspect of the invention, there is provided an edge morphing arrangement for an airfoil, the edge morphing arrangement having a compliant flap arrangement having upper and lower compliant surfaces, the upper an lower compliant surfaces being slidable with respect to each other at a distal tip portion. Upper and lower actuation elements are each coupled to a respectively associated one of the upper and lower compliant surfaces in the vicinity of the distal tip portion. Additionally, a drive arrangement applies respective actuation forces to the upper and lower compliant surfaces via the upper and lower actuation elements.

In one embodiment, the upper and lower actuation elements are provided with upper and lower longitudinal elements that transmit forces between respectively associated ones of the upper and lower compliant surfaces and the drive arrangement. The longitudinal elements are drive cables in some embodiments, and may be rods in other embodiments.

In a further embodiment, the edge morphing arrangement includes a motor for providing mechanical energy. A coupling arrangement couples the motor to the upper and lower longitudinal elements. The motor may be of the rotatory type, or in other embodiments, of the linear type. The coupling arrangement includes a longitudinally displaceable element coupled to the upper and lower longitudinal elements. In some embodiments, the longitudinally displaceable element is a cable, and may be a rod in other embodiments. In embodiments where the longitudinally displaceable element is a cable, there is provided in some such embodiments a pulley for coupling the cable to the motor.

In some embodiments of the invention, there are further provided an airfoil body and a joint for engaging the airfoil body to the compliant flap arrangement. In certain embodiments at least a portion of the drive arrangement is disposed within the airfoil body.

In accordance with a further aspect of the invention, there is provided an airfoil arrangement for a blade of a wind turbine. The airfoil arrangement is provided with a blade body having a longitudinal configuration and an edge. Additionally, there is provided a compliant airfoil edge arrangement disposed along the edge of the blade body for at least a portion of a longitudinal dimension of the blade body.

In one embodiment of this further aspect of the invention, there is further provided a morphing arrangement for changing the aerodynamic characteristics of the airfoil arrangement by reconfiguring the compliant airfoil edge arrangement. In some embodiments, there are provided a plurality of morphing arrangements within the blade body. The plurality of morphing arrangements are, in some embodiments, individually operable to effect a twist configuration on the compliant airfoil edge arrangement.

In a further embodiment, the morphing arrangement includes a motor for providing mechanical energy. Additionally, a coupling arrangement couples the motor to the compliant airfoil edge arrangement. In some such embodiments, the coupling arrangement includes a longitudinally displaceable actuation element for exerting a reciprocating force longitudinally along the blade body. A transversely displaceable actuation element couples the longitudinally displaceable actuation element to the compliant airfoil edge arrangement. In some embodiments, the blade body has a coupling portion for coupling the blade to the wind turbine, and the motor is disposed within the coupling portion. However, in other embodiments, the motor is disposed within the blade body.

In a still further embodiment, there is provided a linear bearing for facilitating displacement of the transversely displaceable actuation element.

### BRIEF DESCRIPTION OF THE DRAWING

Comprehension of the invention is facilitated by reading the following detailed description, in conjunction with the annexed drawing, in which:

FIG. 1 is a cross-sectional representation of a blade having a deformable leading edge constructed in accordance with the principles of the invention;

FIG. 2 is a is a cross-sectional representation of the deformation arrangement of the blade of FIG. 1 without the overlying deformable cover;

FIG. 3 is an isometric representation of a portion of the deformation arrangement of the blade of FIG. 1 without the overlying deformable cover that is useful to illustrate the manner by which longitudinal motion is converted to rotational displacement;

FIG. 4 is an isometric representation of a portion of the deformation arrangement of the blade of FIG. 1 without the overlying deformable covet that is useful to illustrate the manner by which longitudinal motion is converted to rotational displacement;

FIG. 5 is a is a cross-sectional representation of the deformation arrangement of the blade of FIG. 1 showing the deformable portion of the blade in substantially neutral orientation;

FIG. 6 illustrates the actuator layout and representative length scale with respect to the blade span;

FIG. 7 is a schematic representation of a modified flap-actuator;

FIGS. 8(a), 8(b), and 8(c) are simplified schematic representations of a layered structure arrangement that is provided with web-like structures and is formed of a variable thickness core (FIG. 8(b)) or a composite laminate (FIG. 8(c));

FIG. 9 is a simplified schematic representation of the layered structure arrangement without the web-like structures;

FIG. 10 is a simplified schematic representation of the layered structure arrangement with a tailored” core structure, illustratively formed of a cellular material.

FIG. 11 is a simplified schematic representation of an arrangement having a split flap with a core that joins the top and bottom elements;

FIG. 12 is a simplified schematic representation of a fixed-fixed arrangement wherein inward motion of the lower surface effects a change in the shape of the flap;

FIG. 13 is a simplified schematic representation of a standard airfoil having a variable thickness surface perimeter to permit “tailoring” of the perimeter stiffness to achieve a best match for a desired contour;

FIG. 14 is a simplified schematic representation of a thinned/thickened airfoil having a variable thickness surface perimeter to permit “tailoring” of the perimeter stiffness to achieve a best match for a desired contour;

FIG. 15 is a simplified schematic representation of a split flap airfoil arrangement constructed in accordance with the principles of the invention;

FIG. 16 is a simplified schematic representation of a wind turbine of the type that is used to generate electricity from wind power;

FIG. 17 is a simplified cross-sectional schematic representation of an airfoil blade of the wind turbine of FIG. 16;

FIG. 18(a) is a simplified schematic cross-sectional representation of an airfoil blade for a wind turbine, and

FIG. 18(b) is an enlargement of a portion of the airfoil blade of FIG. 18(a) showing an actuation mechanism;

FIG. 19 is a simplified schematic cross-sectional representation of an airfoil blade for a wind turbine that employs a linear bearing in combination with a flap actuator;

FIG. 20 is a simplified schematic representation of the airfoil blade of FIG. 19 illustrating dual actuators for enabling a twist of the airfoil blade upon actuation;

FIG. 21 is a simplified schematic representation of an airfoil blade illustrating dual hydraulic or pneumatic actuators for enabling a compliant deformation, including twist, of the airfoil blade upon actuation, and further showing a pressure line extending through the interior of the airfoil blade;

FIG. 22 is a simplified schematic cross-sectional perspective representation of a wind turbine blade illustrating the installation of an adaptive flap module constructed in accordance with the invention;

FIG. 23 is a simplified schematic cross-sectional perspective representation of the adaptive flap module installed on the wind turbine blade of FIG. 22;

FIG. 24 is a simplified schematic cross-sectional perspective representation of the adaptive flap module installed on the wind turbine blade of FIG. 22 and further showing that the adaptive flap module in this specific illustrative embodiment of the invention spans approximately 25% of the wind turbine blade; and

FIG. 25 is an enlarged simplified schematic cross-sectional representation of the adaptive flap module installed on the wind turbine blade shown in FIG. 23.

### DETAILED DESCRIPTION

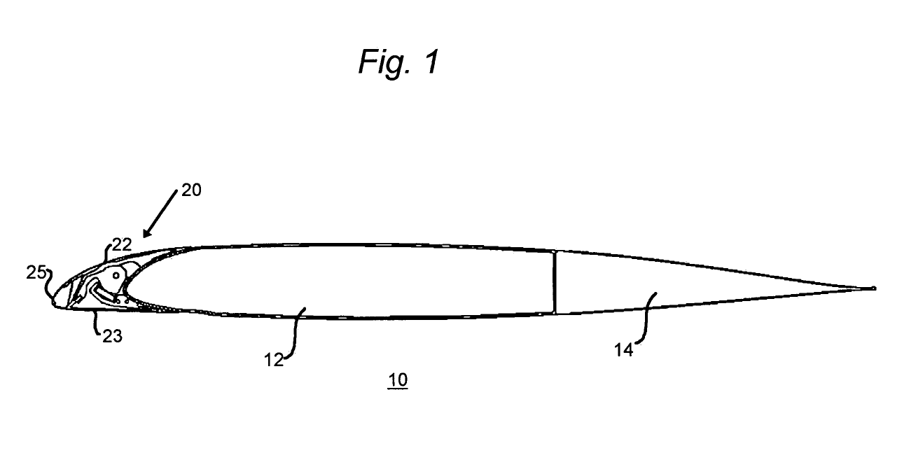

FIG. 1 is a cross-sectional representation of a blade 10 having a deformable leading edge 20. As shown in this figure, blade 10 is additionally provided with a central supporting spar 12 and a trailing edge 14. The deformable leading edge has an overlying compliant cover having an upper portion 22, a lower portion 23, the upper and lower portions being joined at a central forward portion 25.

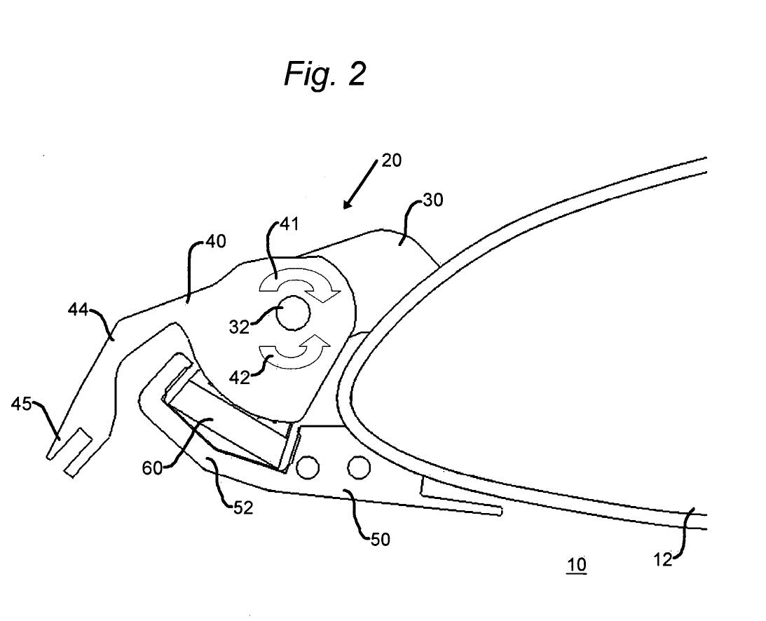

FIG. 2 is a cross-sectional representation of deformation arrangement 20 of blade 10, the deformation arrangement being enlarged to show structural details. The overlying deformable cover has been removed in this figure.

As shown in FIG. 2, spar 12 has attached thereto a support 30 having a pivot 32 to which is attached a rotatory element 40 that it is rotatable about pivot 32 in the direction arrows 41 and 42. Rotatory element to 40 has integrally form therewith an arm portion 44 to which it is attached a coupler portion 45. Rotatory element 40 it is rotatable in response to the longitudinal motion of a cam bar 60. The cam bar is supported by a cam system support 50 having a cam bar support portion 52. In this figure, cam bar 60 is movable longitudinally in and out of the plane of the drawing.

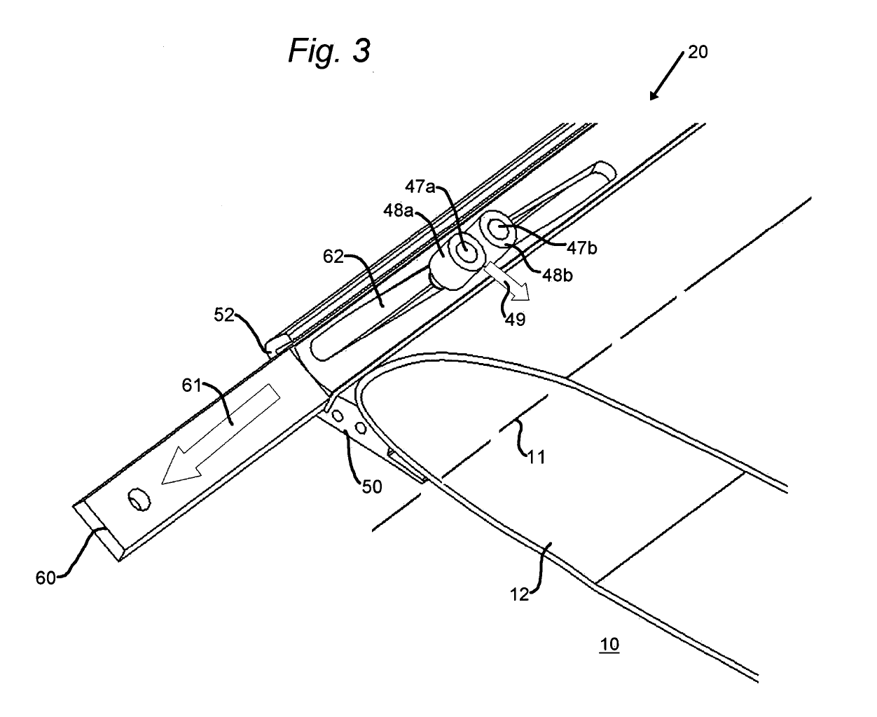

FIG. 3 is an isometric representation of a portion deformation arrangement 20 of blade 10 of FIG. 1. Elements of structure that have previously been described are similarly designated. In this figure, the overlying deformable cover is not shown for sake of clarity. In addition, rotatable element 40 is not shown, but there are shown cams 47a and 47b that are attached to the rotatable element via needle bearings 48a and 48b that facilitate the rotation of the cams. Cams 47a and 47b are shown to be engaged in a slot 62 of cam bar 60. The cams, as will hereinafter be described, are fixed longitudinally in longitudinal relation to longitudinal axis 11 of blade 10, and therefore, as cam bar 60 is displaced in the direction of arrow 61, the cams are displaced transversely in the direction of arrow 49.

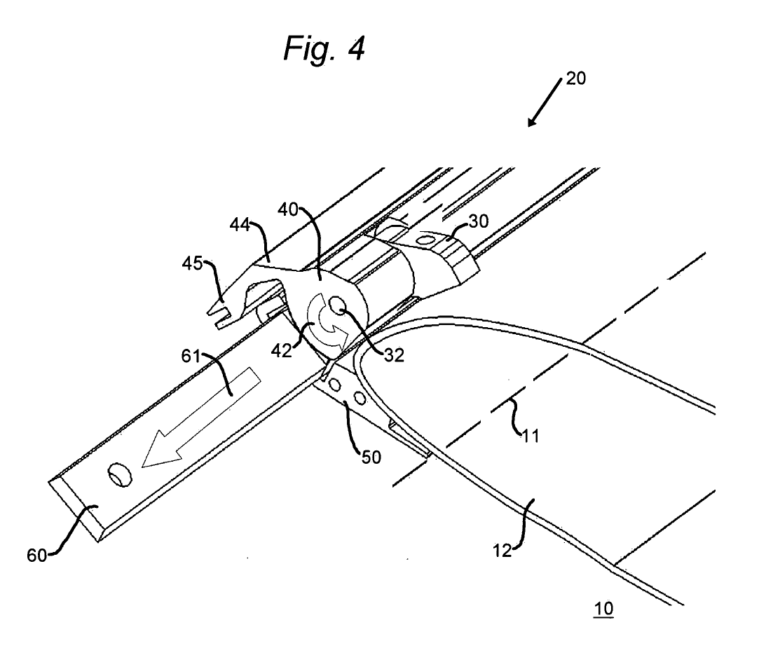

FIG. 4 is an isometric representation of a portion of the deformation arrangement of blade 10 of FIG. 1 with the overlying deformable cover having been removed. Elements of structure that have previously been described are similarly designated. This figure shows that as cam bar 60 is urged in the direction of arrow 61, rotatory element 40 is rotated about pivot 32 in the direction of arrow 42. Thus, arm portion 44 and coupler portion 45 are moved downward. Conversely, when cam bar 60 is urged in a direction opposite to that indicated by arrow 61, rotatory element 40 is rotated in a direction opposite to that indicated by arrow 42, and coupler portion 45 is correspondingly urged upward.

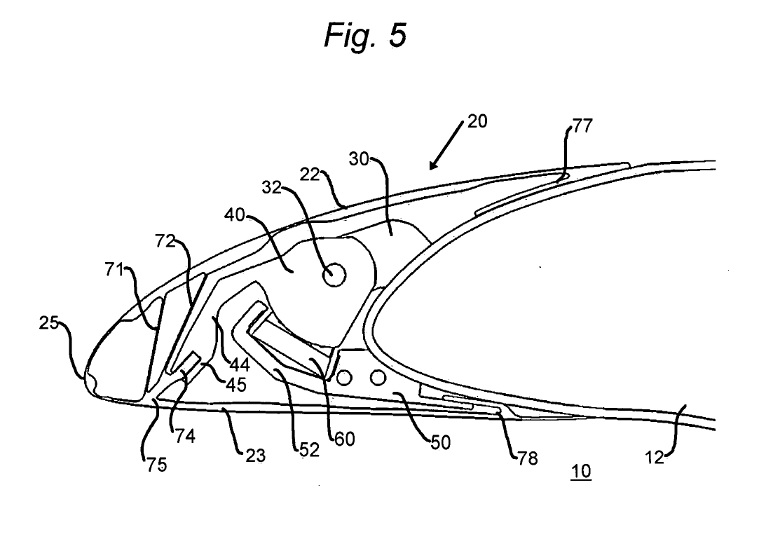

FIG. 5 is a cross-sectional representation of the deformation arrangement of blade 10 of FIG. 1. Elements of structure that have previously been described are similarly designated. In this figure, the deformable cover is installed to form the leading edge of blade 10. The deformable cover consists of an upper portion 22 and a lower portion 23 that are joined together at a frontal portion 25. Upper portion 22 is a fixedly coupled to spar 12 at coupling juncture 77. Lower portion 23, however, is slidably coupled to spar 12 at sliding juncture 78. There are additionally shown in this figure web structures 71 and 72 (shown in cross-section) that are coupled at respective upper ends to upper portion 22 of the deformable cover, and at lower ends of thereof to lower portion 23 at a juncture 75 of a drive link 74. Drive link 74 is shown to be coupled to coupler portion 45 of rotatory element 40. As cam bar 60 is urged a longitudinally along cam bar support portion 52, rotatory element 40 it is rotated, as hereinabove described, whereupon coupler portion 45 of the rotatory element urges drive link 74 upward and downward

### Actuator Selection

One method of actuating the leading edge flap is to provide longitudinal motion along the blade span using a push rod (or a rod in constant tension). This method allows an actuator to be located inboard away from high centrifugal force locations. While investigating various actuation strategies, the motion of the actuator (linear, rotary, or other) along with the system packaging must be considered in order to develop an appropriate method for coupling the motion of the actuator together with the compliant structure. Ideally, the location of the actuator helps leverage (or increase the stiffness of) the leading edge system as much as possible. This may be required in order to maintain a high structural stiffness and integrity (with respect to any undesirable aero-elastic phenomenon such as a critical divergence or shape change due to aerodynamic pressure loads). The actuator characteristics can then be input into the compliant mechanism design algorithms to optimize the system performance.

Information and data of (a) rotary actuators, (b) linear actuators, (c) with or without a speed reduction transmission, (d) embedded actuation concept, and (e) alternative actuation schemes has been compiled. The ultimate actuator choice depends on many factors including: reliability/durability, force/displacement required to drive the compliant control surface, need for a transmission system, packaging, weight (including drive electronics) and power capability. Different solutions may exist due to the specific consideration (criterion) and trade-offs.

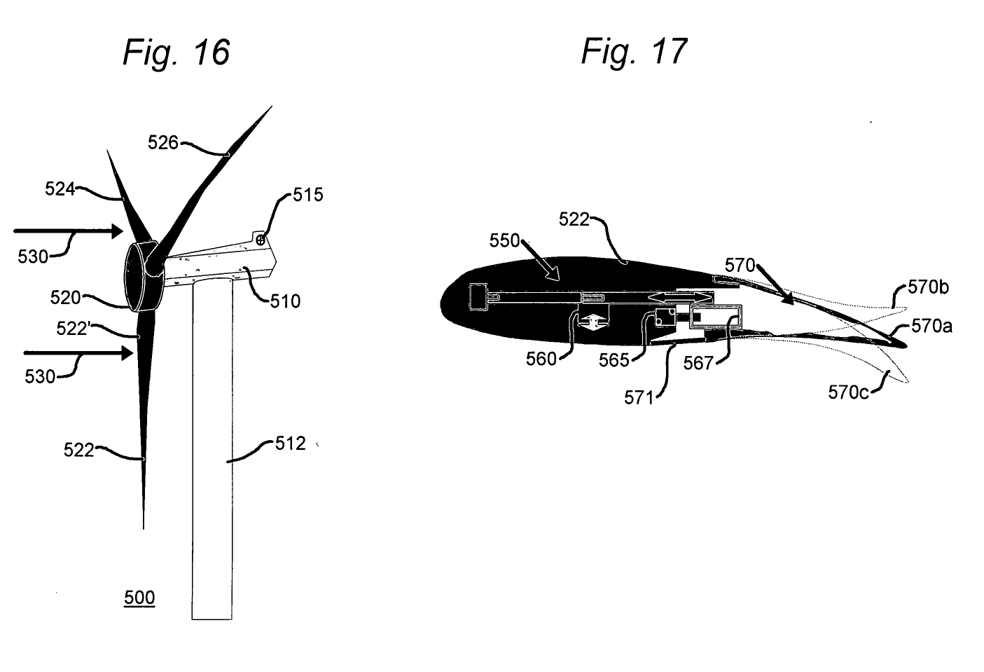

FIG. 16 is a simplified schematic representation of a blade 100, that illustrates the layout of actuator 104 and representative length scale with respect to the blade span. Blade 100 is shown in this figure to have actuator 104 coupled via a balancing spring 106 and a tension rod 108 to a cam system 110 that converts linear to rotary motion, which is applied to compliant flap 109. The actuator is configured in this embodiment to produce motion in accordance with arrow 111. Centrifugal force is shown to be in the direction of arrow 112, toward blade tip 114. The hub of the blade is designated as 116.

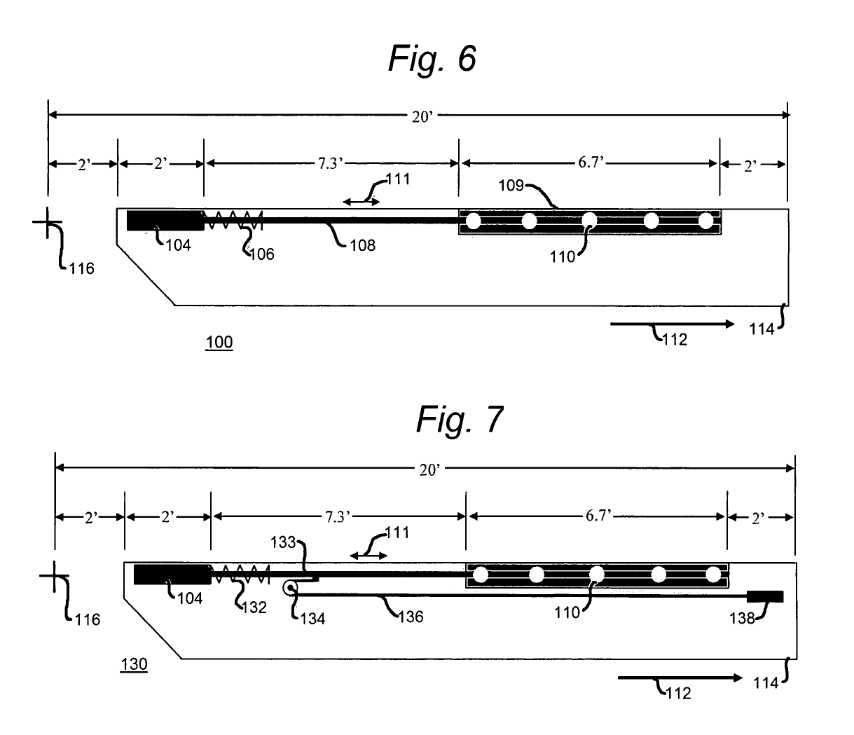

FIG. 7 is a simplified schematic representation of a modified flap-actuator 130. Elements of structure that have previously been discussed are similarly designated in this figure. Actuator 104 is coupled via a tuning spring 132 to tension rod 133. As compared to the embodiment of FIG. 6, the embodiment of FIG. 7 has a redirection pulley 134 that is coupled to a second tension rod 136. Tension rod 136 has, in this embodiment, a balancing weight 138 affixed thereto distal from redirection pulley 134.

The modification represented in FIG. 7 generates a steady offset of the centrifugal force without requiring a heavy and stiff balancing spring. Since the no-flap zone in the last 10% of the blade span and because of the high G loading here, a relatively small mass can be used to generate a balancing force to compensate for the centrifugal force, which is reversed in part by redirection pulley 134, which in some embodiments is configured as a rack and pinion (not shown) or as a pulley system. The linear tuning spring of the present embodiment has much more freedom to be “stiffness tuned” to minimize the impedance of the system at the desired operational frequency. In this manner, actuator force amplitude is reduced. Also, since the tuning linear spring is softer than a balancing spring, the actuator offset force can be significantly reduced. Analysis of the packaging space within the leading edge reveals that there is room to place the second thin tension rod 136, which may be configured in some embodiments to have ˜½″ cross-sectional diameter, and yet will have adequate strength and stiffness to support the balancing mass 138 located at rotor tip 114. Of course, balancing mass 138 adds additional weight and complexity to the system, but this additional weight is likely to be significantly less than the added mass of some 12 heavy-duty helical tension balancing springs.

As shown in FIG. 7, the linear actuator is located near hub 116 of the blade, thereby isolating the actuator from high centrifugal loading. The linear actuator will transmit power to the leading edge flap using a tension rod where maximum stiffness of the transmission is obtained using a carbon fiber rod in tension/compression rather than torsion or bending (higher structural efficiency). A balancing spring will compensate for centrifugal loading acting on the tension rod.

The linear actuator motion will be transferred to rotary motion to drive the main rotary link using a cam-type system designed to be very compact, lightweight and stiff in the rotary direction. Along the flap span, there will be cam stations at intervals. Spacing should be determined based on component space, the mechanical advantage of the cam system (stroke of the tension rod versus rotation of the drive link), and the stiffness and allowable drag (damping) of the cam system.

It is an important aspect of the tension rod approach of the present invention that the actuation rod is always in tension. As such, therefore, the actuation force constitutes but a reduction in the tension in such an embodiment. This approach to the design of the system avoids buckling of the actuation rod, as would he the case with compression.

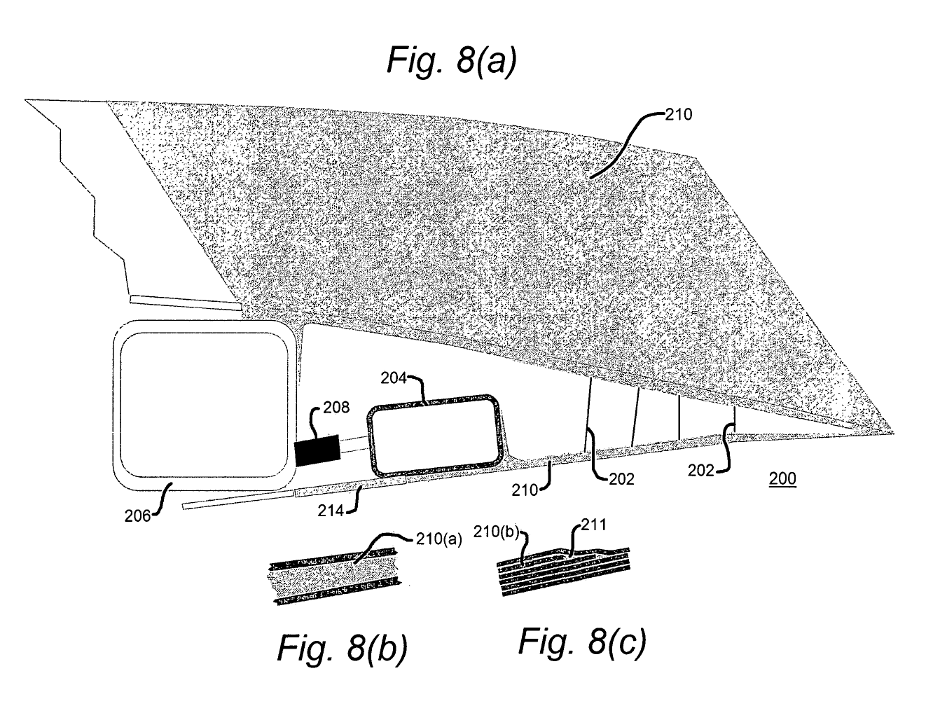

FIGS. 8(a), 8(b), and 8(c) are simplified schematic representations of a layered structure arrangement 200 that is provided with web-like structures 202 that are, in this specific illustrative embodiment of the invention, bonded to compliant skin 210, which will be described in greater detain in connection with FIGS. 8(b) and 8(c), below. Referring to FIG. 8(a), layered structure arrangement 200 is shown to be provided with a drive bar 204 that applies a linear force against rear wing spar 206 by operation of an actuator 208. The motion of drive bar 204 is transmitted to a compliant skin 210, the motion of the compliant skin being accommodated by a sliding joint 214 that in some embodiments of the invention may be configured as an elastomer panel (not shown).

FIG. 8(b) is a representation of compliant skin 210 that is formed, in this specific illustrative embodiment of the invention, of a variable thickness core 210(a). Alternatively, FIG. 8(c) shows compliant skin 210 to be a multiple-ply composite laminate 210(b) wherein the plies are staggered to facilitate control over thickness. As shown, the composite laminate plies are bonded to each other with a laminating adhesive 211. The composite layers are configured from the standpoint of ply orientation, fiber weave, selection of adhesive, etc. the achieve a desired compliant structure stiffness and strength.

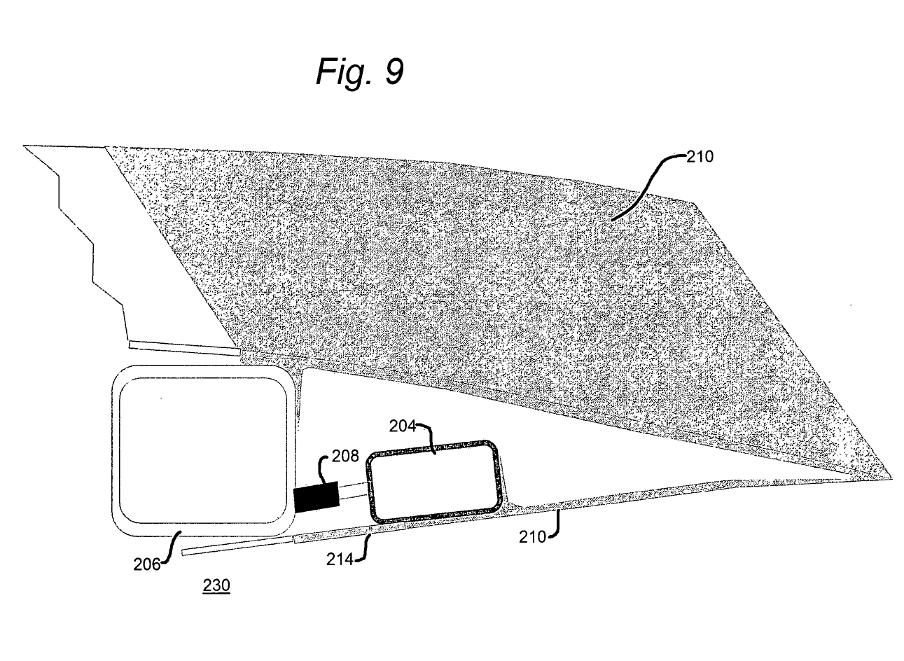

FIG. 9 is a simplified schematic representation of layered structure arrangement 230, without the web-like structures described in FIG. 8(a). Elements of structure that have previously been discussed are similarly designated in this figure.

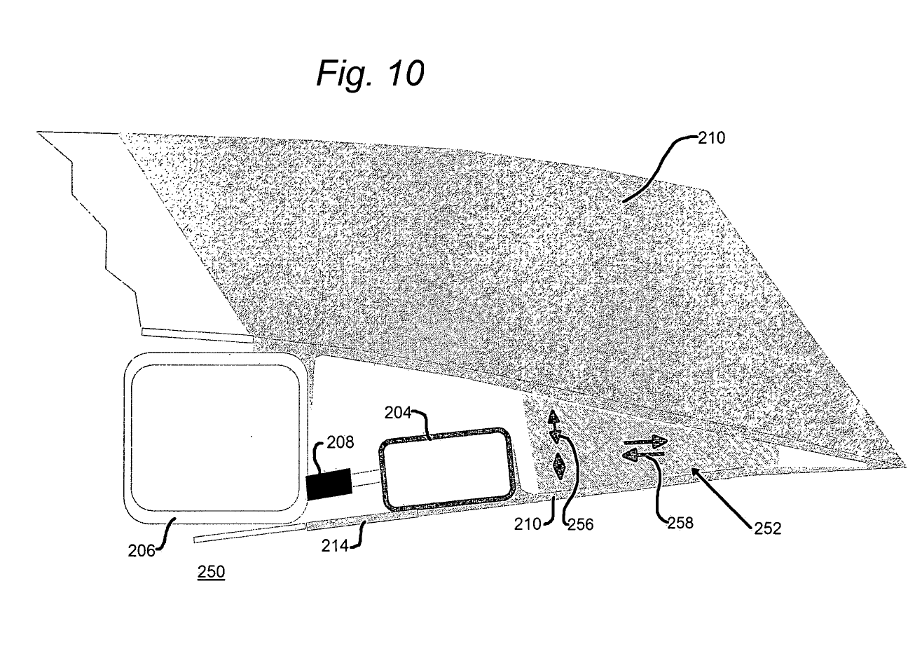

FIG. 10 is a simplified schematic representation of the layered structure arrangement 250 with a tailored” core structure 252, illustratively formed of a cellular material. Core structure 252 is, in this specific illustrative embodiment of the invention, configured to have a high stiffness characteristic in the substantially vertical direction indicated by arrow 256, and a low stiffness characteristic in the substantially horizontal direction indicated by arrows 258.

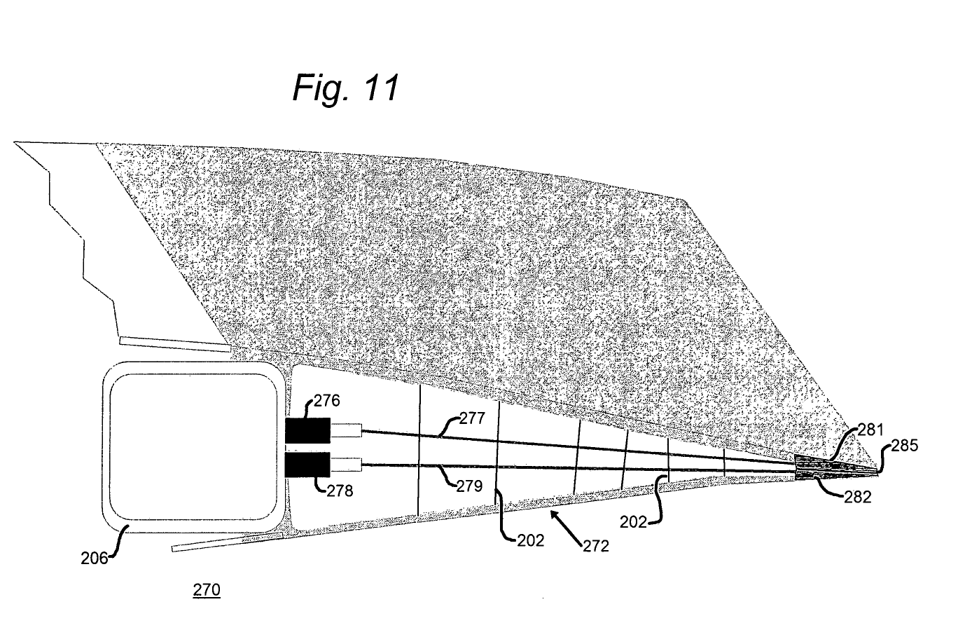

FIG. 11 is a simplified schematic representation of a fixed-fixed arrangement 270 wherein inward motion of lower surface 272 effects a change in the shape of the flap. In this embodiment, two actuators 276 and 278 are coupled by respectively associated ones of antagonistic drive cables 277 and 279, to respectively associated ones of trailing edge tip spars 281 and 282. In some embodiments, drive cables 277 and 279 may be replaced with rods (not shown). Tip spars 281 and 282 are configured to slip against each other at sliding joint 285.

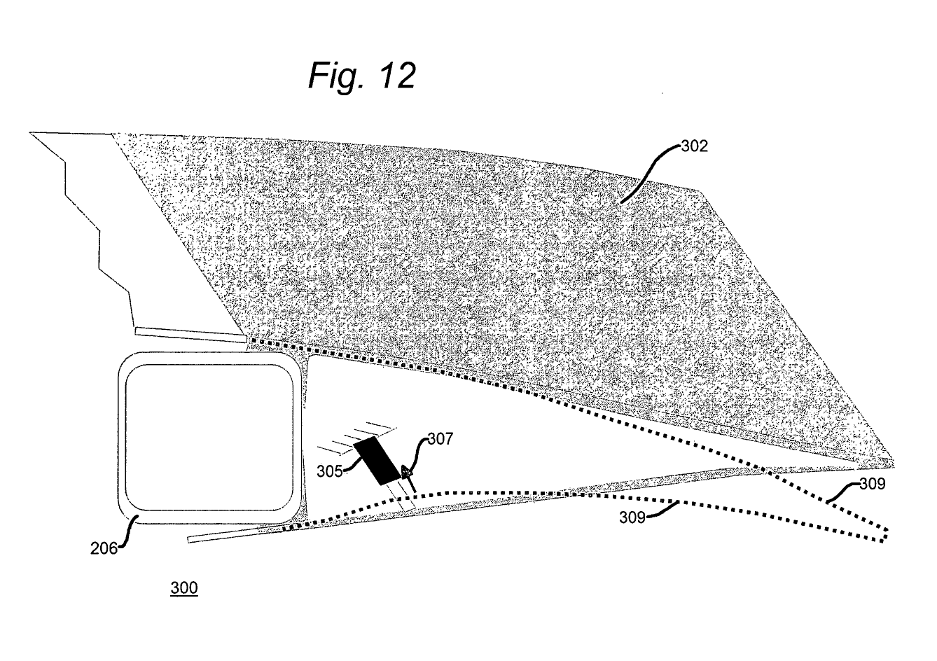

FIG. 12 is a simplified schematic representation of a standard airfoil 300 having a variable thickness surface perimeter 302 to permit “tailoring” of the perimeter stiffness to achieve a best match for a desired contour. When actuator 305 is operated toward inward motion as indicated by the direction of arrow 307, the contour of variable thickness surface perimeter 302 is urged into the configuration represented in phantom and designated as 309. In this embodiment, there is no sliding joint or elastomer surface on either the top or bottom surface, thus it is termed a “fixed-fixed” configuration.

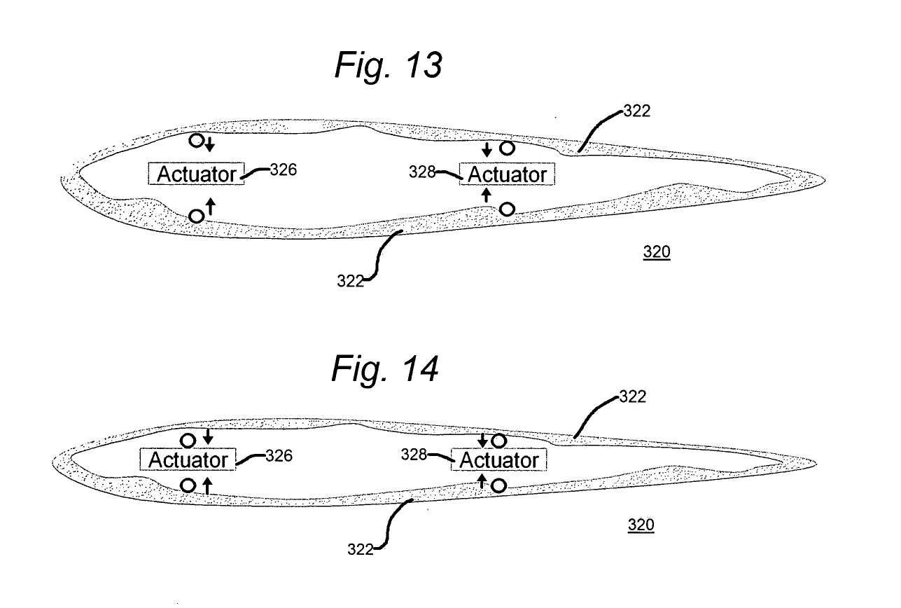

FIG. 13 is a simplified schematic representation of a standard airfoil 320 having a variable thickness surface perimeter 322 that permits “tailoring” of the perimeter stiffness to achieve a best match for a desired contour. That is, the varying wing thickness allows the perimeter stiffness to be “tailored” to facilitate the design of an advantageous contour characteristic. Thinning of the airfoil is effected by causing actuators 326 and 328 to pull inward in the direction of the arrows.

FIG. 14 is a simplified schematic representation of airfoil 320 that has been “thinned” by operation of the actuators, as discussed hereinabove in relation to FIG. 13.

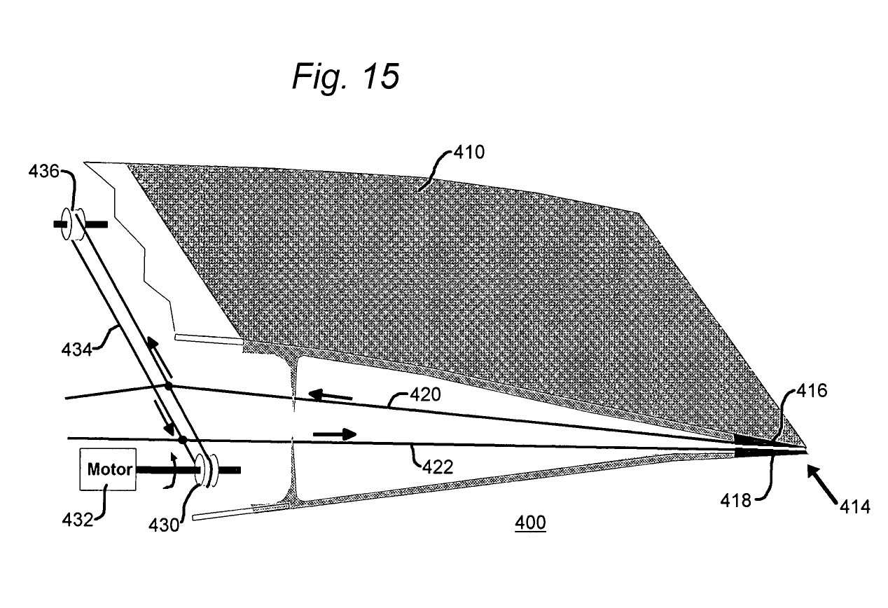

FIG. 15 is a simplified schematic representation of a split flap airfoil arrangement 400 constructed in accordance with the principles of the invention. As shown in this figure, split flap airfoil arrangement 400 has a compliant structural skin 410 that, in this specific illustrative embodiment of the invention, is formed of composite layers (not specifically designated). The composite layers have a predetermined ply orientation and fiber weave, the various plies being maintained in relation to one another by an adhesive (not shown). In this embodiment, compliant structural skin 410 has a thickness that varies over the surface thereof to achieve a desired compliance characteristic.

Split flap airfoil arrangement 400 is shown to have a tip sliding joint 414 that is formed of an upper trailing edge tip spar 416 and a lower trailing edge tip spar 418. The upper and lower trailing edge tip spars are each coupled to a respective one of antagonistic drive cables 420 and 422.

There is additionally provided in this embodiment an actuation pulley 430 that is coupled to the shaft of drive motor 432. An actuation cable loop 434 is arranged around actuation pulley 430, and an idler pulley 436. In this specific illustrative embodiment of the invention, drive cable 420 is coupled to the upper segment of cable loop 434, and drive cable 422 is coupled to the lower segment of cable loop 434. Thus, as drive motor 432 is rotated in the direction of the curved arrow, the upper an lower sections of drive cable 420 are urged in the opposite directions indicated by the arrows, causing drive cables 420 and 422 to be urged in opposite directions.

In the practice of this aspect of the invention, other mechanisms may be employed to facilitate the selective application of tensile forces to the respective drive cables. For example, in some embodiments antagonistic drive cables 420 and 422 are not fixedly coupled to actuation cable loop 434, but instead are permitted to slide therealong. Cable loop 434 is provided with stops (not shown) fixed thereto that permit the drive cables to be urged in only one direction, thereby avoiding tensile forces to be applied to both drive cables simultaneously.

FIG. 16 is a simplified schematic representation of a wind turbine 500 of the type that is used to generate electricity from wind power. As shown in this figure, wind turbine 500 has a generator 510 installed atop of a support stanchion 512. Generator 510 has a hub 520 coupled thereto, to which are attached in this embodiment three turbine blades 522, 524, and 526. Turbine blade 522, for example, has a coupling portion 522′ that engages with hub 520. Wind, illustratively in the direction of arrows 530, will cause the turbine blades and the hub to rotate, consequently causing generator 510 to produce an electric current. In an advantageous embodiment of the invention, a sensor 515 is provided for issuing sensor data (not shown) that is applied to control the extent to which the compliant flap (not specifically designated in this figure) is deformed. In other embodiments, such sensors (not shown) are disposed in hub 520 and/or in stanchion 512. In addition, the sensor data can, in some embodiments of the invention, be applied to control the turbine blades individually or collectively.

As previously noted, in some embodiments the sensor monitors ambient conditions that might affect the operation of the wind turbine, and in such embodiments, the sensor is disposed in the vicinity (not shown) of the wind turbine, illustratively remotely in a field near the wind turbine. In other embodiments, a remote sensor will provide data to a plurality of wind turbines (not shown).

FIG. 17 is a simplified cross-sectional schematic representation of airfoil blade, illustratively airfoil blade 522 of wind turbine 500. Elements of structure that have previously been discussed are similarly designated in this figure. Airfoil blade 522 is shown to have a drive linkage system 550 that is actuated by a push/pull rod 560. Push/pull rod 560 is linearly displaceable in and out of the plane of the figure. There is additionally provided a linear bearing 565 that in this embodiment is coupled to a drive bar 567. Actuation of the drive bar causes compliant flap 570 to assume neutral (570a), upward (570b) or downward (570c) positions, and of course, positions therebetween. Displacement of the skin that would result from the transitions between the upward and downward positions is accommodated in this specific illustrative embodiment of the invention by skin element 571, which is an elastomeric element, and in other embodiments is a sliding joint.

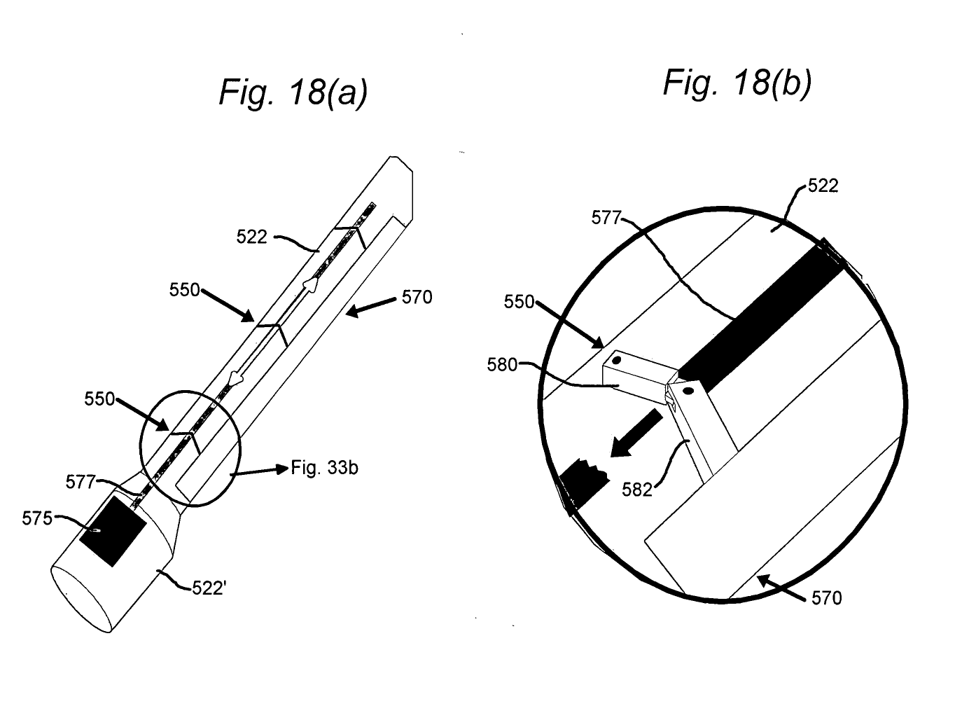

FIG. 18(a) is a simplified schematic representation of airfoil blade 522 for wind turbine 500, and FIG. 18(b) is an enlargement of a portion of airfoil blade 522 showing an actuation mechanism 550. Actuation mechanism 550 is operated by the axial translation of an actuation rod 577 that is coupled to a drive motor 575. The drive motor may be a linear motor, and in other embodiments, a rotatory motor. In this specific illustrative embodiment of the invention, drive motor 575 is disposed within coupling section 522′ of airfoil blade 522. In other embodiments, the drive motor may be incorporated within hub 520, and in further embodiments, a single drive motor within the hub can be used to operate the reconfiguration of all three airfoil blades simultaneously (see, FIG. 16).

As can be seen in FIG. 18(b), the actuation of drive motor 575 causes actuation rod 577 to be axially displaced, illustratively in a reciprocating motion. This causes actuation arms 580 and 582 to pivot at the pivot couplings on the actuation rod, whereby compliant flap 570 is correspondingly displaced upward and downward.

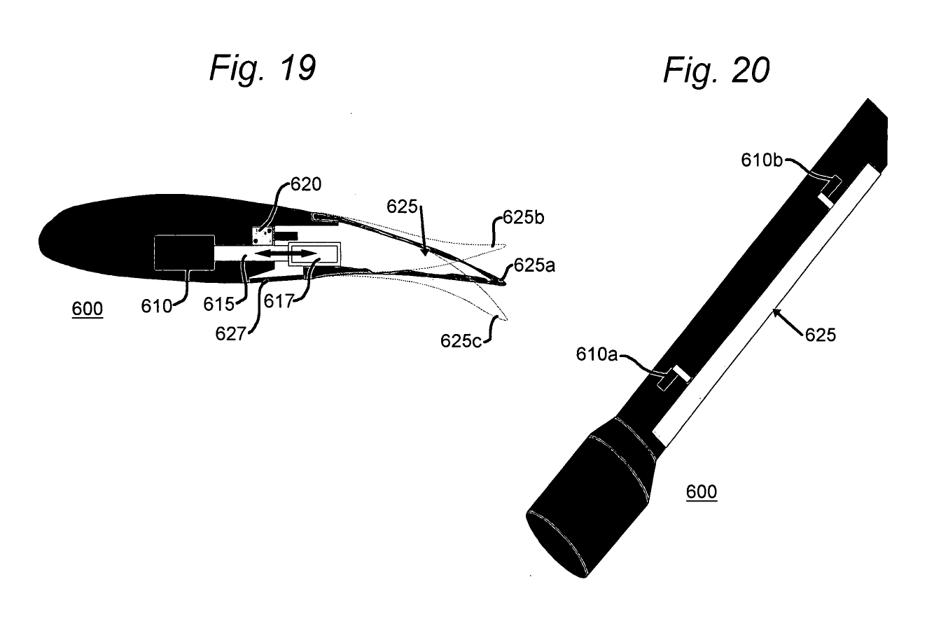

FIG. 19 is a simplified schematic cross-sectional representation of an airfoil blade 600 for a wind turbine (not shown in this figure). In this embodiment, a drive motor 610 coupled to an actuator shaft 615 urges a drive bar 617 in the directions indicated by the two-headed arrow. A linear bearing 620 cooperates with the in combination with a flap actuator. The operation of the drive motor causes a compliant flap 625 to be displaced between neutral (625a), upward (625b) and downward (625c) positions. Displacement of the skin that would result from the transitions between the upward and downward positions is accommodated in this specific illustrative embodiment of the invention by skin element 627, which is an elastomeric element, and in other embodiments is a sliding joint. In this embodiment of the invention, the drive motor is disposed within airfoil blade 600.

FIG. 20 is a simplified schematic representation of airfoil blade 600, and further shows that a plurality of actuation arrangements can be disposed within the airfoil blade. More specifically, This figure illustrates dual actuators 610a and 610b that are individually operable. Thus, uniform and non-uniform configurations of the airfoil blade can be achieved, resulting in, for example, twisting of the compliant flap of the airfoil blade.

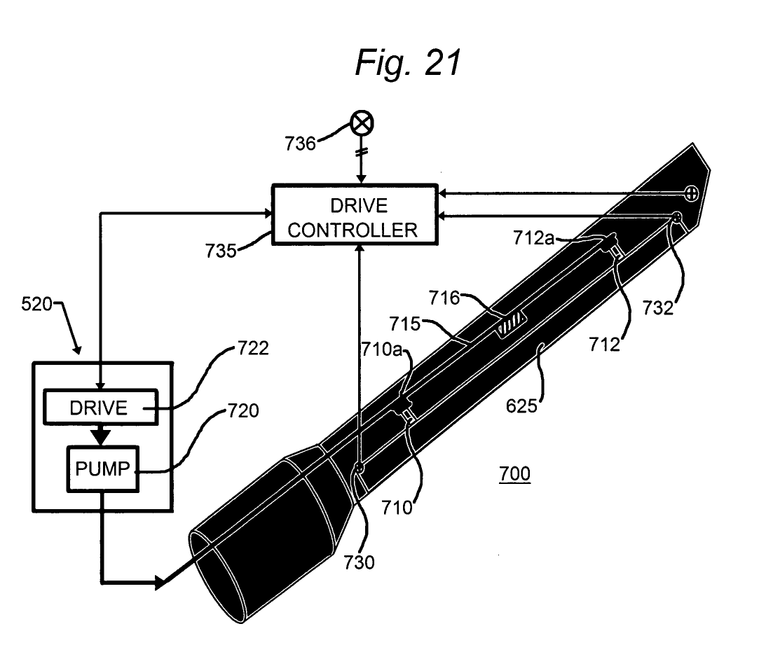

FIG. 21 is a simplified schematic representation of an airfoil blade 700 illustrating hydraulic (or pneumatic) actuators 710 and 712. Elements of structure that have previously been discussed are similarly designated. Actuators 710 and 712 enable upon actuation a compliant deformation, including twist, of compliant flap 625. There is additionally shown in this figure a pressure line 715 extending through the interior of the airfoil blade. In this embodiment of the invention, pressure line 715 is coupled to a pump 720 contained within hub 520. The pump and the hub are schematically represented in this figure. An accumulator is, in this embodiment, disposed in the vicinity of actuators 710 and 712. In other embodiments, however, the accumulator is installed in the hub.

Hydraulic pressure from pressure line 715 is delivered to actuators 710 and 712 by operation of respectively associated hydraulic valves 710a and 712a. In this specific embodiment, hydraulic valve 710a is operated mechanically, such as by cables (not shown). Hydraulic valve 712a is operated electrically, such as by a solenoid (not shown).

In the practice of a specific illustrative embodiment of the invention, the pump is actuated by a drive arrangement 722 that is responsive to, and draws mechanical energy from, the rotation of the hub in relation to the nacelle (not shown in this figure). Alternatively, drive arrangement 722 constitutes a motor (not specifically designated) that can easily be maintained, repaired, or replaced. The motor is arranged in some embodiments to draw electrical energy from the wind turbine.

Drive arrangement 722 has associated therewith in some embodiments one or more position sensors or encoders that provide corresponding control over the deformation of compliant flap 625. Such sensors or encoders (not shown) are installed within hub 520 or in the motor itself. In other embodiments, however, one or more sensors or encoders are provided on the blade to ensure precise control over the deformation of compliant flap 625. In a specific illustrative embodiment of the invention, encoders 730 and 732 provide position signals to a drive controller 735. The encoders and the motor controller are schematically illustrated in this figure. In some embodiments of the invention, particularly in situations where the benefits of the present invention are retrofitted into existing wind turbine systems, drive controller 735 is incorporated into a preexisting system control unit (not shown).

In some embodiments, a sensor 740 is installed on the airfoil blade to provide data relating to wind speed, turbine rotation, blade loading, actuator loading, etc. The data generated by sensor 740 is provided in this specific illustrative embodiment of the invention to drive controller 735 and is used to control the operation of drive arrangement 722. In other embodiments, where the pump is actuated by rotation of the hub in relation to the nacelle, the functionality of drive controller 735 is applied to control the coupling (not shown) between the pump and the hub.

In other embodiments of the invention, at least one remote sensor 736 is provided in the vicinity of the wind turbine. The remote sensor is in some embodiments located in a field, illustratively a farm of wind turbines (not shown) and can provide data that is employed to control the morphing of a plurality of wind turbines. The communication between remote sensor 736 and the motor controller includes, in certain embodiments, a radio link (not specifically designated).

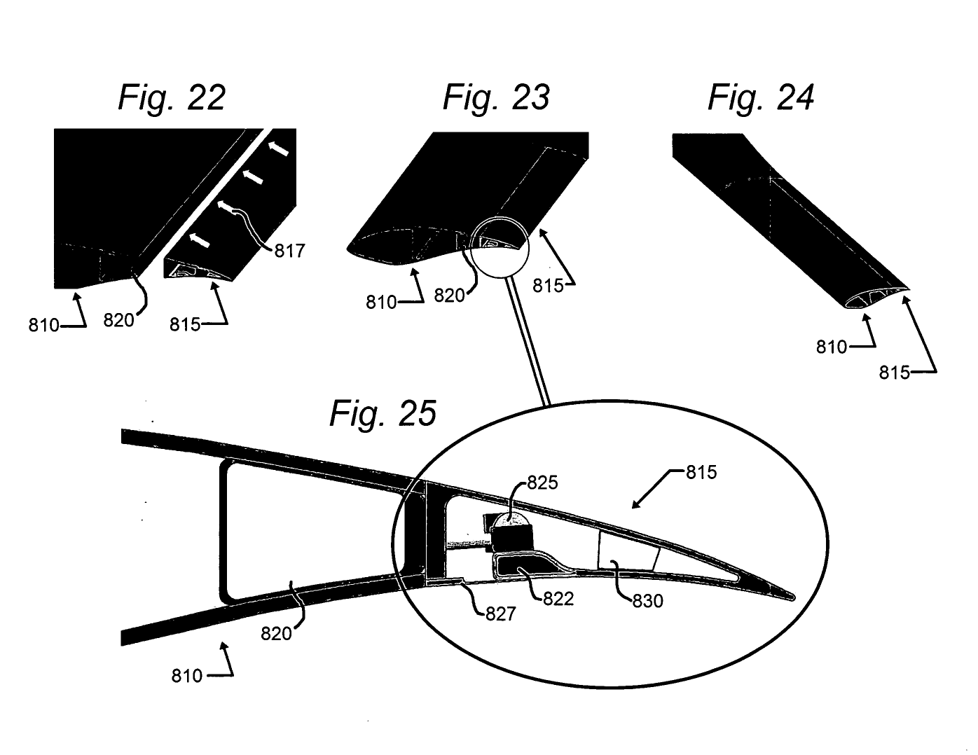

FIG. 22 is a simplified schematic cross-sectional perspective representation of a wind turbine blade 810 illustrating the installation of an adaptive flap module 815 constructed in accordance with the invention. Installation of flap module 815 is achieved by sliding same toward the leading edge of wind turbine blade 810 in the direction of arrows 817 and fastening the flap module to the wind turbine blade at rear wing spar 820. In other embodiments, the flap module is installed on wind turbine blade 810 by sliding same longitudinally along a slot or groove (not shown).

FIG. 23 is a simplified schematic cross-sectional perspective representation of the adaptive flap module installed on the wind turbine blade of FIG. 22. Elements of structure that have previously been discussed are similarly designated. The flap module 815 in this embodiment of the invention is easily removed for maintenance, repair, and replacement.

FIG. 24 is a simplified schematic cross-sectional perspective representation of the adaptive flap module installed on the wind turbine blade of FIG. 22 and further showing that the adaptive flap module in this specific illustrative embodiment of the invention spans approximately 25% of the wind turbine blade. Elements of structure that have previously been discussed are similarly designated.

In this specific illustrative embodiment of the invention, flap module 815 provides a camber change of ±10° or more and a spanwise twist of ±10° or more. The invention is not limited to a removable cartridge flap compliant, as in some embodiment of the invention the flap is formed integrally with the wind turbine blade. Additionally, in various embodiments of the invention the actuators and sensors can be incorporated into the wind turbine blade and/or the compliant flap.

FIG. 25 is an enlarged simplified schematic cross-sectional representation of adaptive flap module 815 installed on wind turbine blade 810, as shown in FIGS. 22-24. Elements of structure that have previously been discussed are similarly designated. This figure shows flap module 815 coupled to wind turbine blade 810 at rear wing spar 820. In addition, the figure shows a drive bar 822 that, in this specific illustrative embodiment of the invention, is formed integrally with flap module 815.

An actuator 825 applies a deformation force against drive bar 822 to effect the deformation of flap module 815. The actuating portion of actuator 825 is located in some embodiments in wind turbine blade 810, and in other embodiments in flap module 815. In further embodiments, there is provided a linear bearing (not shown in this figure), as discussed above, particularly in relation to FIG. 19.

In addition to receiving the deformation force, drive bar 822 provides stiffness for distributing the actuation force and provides distributed bending stiffness for adaptive flap module 815.

The compliant flexing and straightening of the skin (not specifically designated) is accommodated, as previously noted, by an elastomeric element 827. In other embodiments, a sliding joint is employed instead of the elastomeric element. Moreover, a flap spar 830 is included in this embodiment of the invention having a predetermined stiffness characteristic that may, in some embodiments, constitute different stiffness characteristics along different axes.

Although the invention has been described in terms of specific embodiments and applications, persons skilled in the art may, in light of this teaching, generate additional embodiments without exceeding the scope or departing from the spirit of the invention described and claimed herein. Accordingly, it is to be understood that the drawing and description in this disclosure are proffered to facilitate comprehension of the invention, and should not be construed to limit the scope thereof.

What is claimed is:

1. A wind turbine of the type having at least one airfoil blade having a longitudinal configuration for exerting a torque on a generator in response to an impinging air current, the wind turbine comprising:
a generator for producing electrical energy in response to the application of a rotatory force;
a compliant airfoil edge arrangement disposed along an edge of the airfoil blade for at least a portion of a longitudinal dimension of said airfoil blade; and
a morphing drive arrangement for varying a configuration of said compliant airfoil edge arrangement and thereby varying the aerodynamic characteristics of the airfoil blade and said compliant airfoil edge arrangement.

2. The wind turbine of claim 1, wherein there is further provided:
a sensor for providing data responsive to a predetermined condition of operation of said compliant airfoil edge; and
a controller for controlling the operation of said morphing drive in response to the data issued by said sensor.

3. The wind turbine of claim 2, wherein said sensor is disposed in the vicinity of the wind turbine.

4. The wind turbine of claim 1, wherein said compliant airfoil edge is arranged as a trailing edge of said airfoil blade.

5. The wind turbine of claim 1, wherein said morphing drive arrangement comprises a push-pull axial rod extending longitudinally along at least a portion of said airfoil blade.

6. The wind turbine of claim 5, wherein there is further provided a linkage arrangement for converting a longitudinal motion of said push-pull axial rod into translongitudinal motion.

7. The wind turbine of claim 1, wherein said morphing drive arrangement comprises an electromechanical actuator that provides an actuation force for varying a configuration of said compliant airfoil edge arrangement.

8. The wind turbine of claim 1, wherein said morphing drive arrangement comprises a hydraulic actuator that provides an actuation force for varying a configuration of said compliant airfoil edge arrangement.

9. The wind turbine of claim 8, wherein there is further provided:
a hydraulic pump for providing a pressurized hydraulic fluid; and
a hydraulic line extending along the airfoil blade for providing fluid coupling between said hydraulic pump and said hydraulic actuator.

10. The wind turbine of claim 9, wherein there is further provided a motor for providing mechanical energy to said hydraulic pump.

11. The wind turbine of claim 9, wherein there is further provided a coupling arrangement for providing mechanical energy to said hydraulic pump in response to the torque exerted by the airfoil blade.

12. The wind turbine of claim 9, wherein there is further provided:
a sensor for providing data responsive to a predetermined condition of operation of the wind turbine; and
a controller for controlling the operation of said hydraulic pump in response to the data issued by said sensor.

13. The wind turbine of claim 12, wherein said sensor is disposed on the airfoil blade.

14. The wind turbine of claim 12, wherein there is further provided a housing for the generator, and said sensor is disposed on said housing.

15. The wind turbine of claim 14, wherein there is further provided a support stanchion for supporting the generator, and said sensor is disposed on said stanchion.

16. The wind turbine of claim 12, wherein said sensor is arranged to provide data responsive to the extent of deformation of said compliant airfoil edge arrangement.

17. The wind turbine of claim 8, wherein there is further provided a hydraulic valve for controlling the application of hydraulic pressure to said hydraulic actuator.

18. The wind turbine of claim 17, wherein said hydraulic valve is actuated electrically.

19. The wind turbine of claim 18, wherein said hydraulic valve is actuated mechanically.

20. The wind turbine of claim 1, wherein said compliant airfoil edge arrangement is configured as a replaceable cartridge installed on the airfoil blade.

21. The wind turbine of claim 20, wherein said replaceable cartridge extends approximately between 10% and 90% of the longitudinal configuration of the airfoil blade.

22. The wind turbine of claim 1, wherein there is further provided a drive bar extending along said compliant airfoil edge arrangement for facilitating coupling of said compliant airfoil edge arrangement with said morphing drive arrangement.

23. The wind turbine of claim 22, wherein said drive bar is formed integrally with said compliant airfoil edge arrangement.

24. The wind turbine of claim 22, wherein said drive bar imparts a predetermined stiffness characteristic to said compliant airfoil edge arrangement.

25. The wind turbine of claim 1, wherein there is further provided a stiffness control element for imparting a predetermined stiffness characteristic to said compliant airfoil edge arrangement.

26. The wind turbine of claim 1, wherein there is further provided a linear bearing for movably supporting said morphing drive arrangement.

27. The wind turbine of claim 1, wherein said compliant airfoil edge arrangement is provided with upper and lower surfaces that communicate with one another at an apex.

28. The wind turbine of claim 27, wherein said upper and lower surfaces are arranged to slide against one another at the apex.

29. An edge morphing arrangement for an airfoil, the edge morphing arrangement comprising:
a compliant flap arrangement having upper and lower compliant surfaces, the upper an lower compliant surfaces being slidable with respect to each other at a distal tip portion;
upper and lower actuation elements each coupled to a respectively associated one of the upper and lower compliant surfaces in the vicinity of the distal tip portion; and
a drive arrangement for applying respective actuation forces to the upper and lower compliant surfaces via said upper and lower actuation elements.

30. The edge morphing arrangement of claim 29, wherein said upper and lower actuation elements comprise upper and lower longitudinal elements that transmit forces between respectively associated ones of the upper and lower compliant surfaces and said drive arrangement.

31. The edge morphing arrangement of claim 30, wherein the longitudinal elements are drive cables.

32. The edge morphing arrangement of claim 30, wherein said drive arrangement comprises:
a motor for providing mechanical energy; and
a coupling arrangement for coupling said motor to the upper and lower longitudinal elements.

33. The edge morphing arrangement of claim 32, wherein said motor is a rotatory motor.

34. The edge morphing arrangement of claim 32, wherein said coupling arrangement comprises a longitudinally displaceable element coupled to the upper and lower longitudinal elements.

35. The edge morphing arrangement of claim 34, wherein the longitudinally displaceable element is a cable.

36. The edge morphing arrangement of claim 35, wherein there is further provided a pulley for coupling the cable to said motor.

37. The edge morphing arrangement of claim 34, wherein the longitudinally displaceable element is a rod.

38. The edge morphing arrangement of claim 29, wherein there are further provided;
an airfoil body; and
a joint for engaging said airfoil body to said compliant flap arrangement.

39. The edge morphing arrangement of claim 38, wherein at least a portion of said drive arrangement is disposed within said airfoil body.

40. An airfoil arrangement for a blade of a wind turbine, the airfoil arrangement comprising:
a blade body having a longitudinal configuration and an edge; and
a compliant airfoil edge arrangement disposed along the edge of said blade body for at least a portion of a longitudinal dimension of said blade body.

41. The airfoil arrangement of claim 40, wherein there is further provided a morphing arrangement for changing the aerodynamic characteristics of the airfoil arrangement by reconfiguring said compliant airfoil edge arrangement.

42. The airfoil arrangement of claim 41, wherein there are provided a plurality of morphing arrangements within said blade body.

43. The airfoil arrangement of claim 42, wherein said plurality of morphing arrangements are individually operable to effect a twist configuration on said compliant airfoil edge arrangement.

44. The airfoil arrangement of claim 41, wherein said morphing arrangement comprises:
a motor for providing mechanical energy; and
a coupling arrangement for coupling said motor to the compliant airfoil edge arrangement.

45. The airfoil arrangement of claim 44, wherein said coupling arrangement comprises:
a longitudinally displaceable actuation element for exerting a reciprocating force longitudinally along said blade body; and
a transversely displaceable actuation element for coupling said longitudinally displaceable actuation element to said compliant airfoil edge arrangement.

46. The airfoil arrangement of claim 45, wherein said blade body has a coupling portion for coupling the blade to the wind turbine, and said motor is disposed within said coupling portion.

47. The airfoil arrangement of claim 46, wherein said motor is disposed within said blade body.

48. The airfoil arrangement of claim 45, wherein there is further provided a linear bearing for facilitating displacement of said transversely displaceable actuation element.
